(19) United States
(12) Patent Application Publication
(10) Pub. No.: US 2010/0236931 A1
(43) Pub. Date: Sep. 23, 2010

(54) IMPROVEMENTS IN/OR RELATING TO A METHOD OF TREATING SLUDGES

(76) Inventor: Tissa Fernando, Auckland (NZ)

Correspondence Address: KEVIN J. MCNEELY, ESQ., 5335 WISCONSON AVENUE, NW, SUITE 440, WASHINGTON, DC, 20015, US

(21) Appl. No.: 12/675,388

(22) PCT Filed: Jul. 30, 2008
(86) PCT No.: PCT/NZ2008/000188

§ 371 Date: Feb. 25, 2010

(30) Foreign Application Priority Data
Jul. 30, 2007 (NZ) 561695

(51) Int. Cl. C02F 11/12; C02F 9/12; C02F 11/14

(52) U.S. Cl. 204/545; 204/553

(57) ABSTRACT

The invention comprises a method of treating sludges which includes the steps of applying an electric field to the sludge to effect dewatering prior to further dewatering of the sludge. Typically the sludge comprises dilute phase sludge, and the electric field is a DC electric field. The pH of the sludge may be adjusted to between substantially 5 and substantially 6 prior to applying the electric field.

### TECHNICAL FIELD OF THE INVENTION

This invention relates to a method of treating sludges and has been designed particularly though not necessarily solely for use in the treatment of biosolids.

### BACKGROUND ART

The treatment of sewage sludge results in a final residue for disposal. This residue is often referred to as biosolids. The dry solids (DS) contents of the biosolids varies typically from 0.5% DS to 4% DS. The production of this dilute phase sludge from treated waste water depends on the type of treatment process used. Typically, the dilute phase is discharged from a process comprising of mesophilic digesters, thermophilic digesters, extended aeration, activated sludge, waste activated sludge, primary treatment, sequencing batch reactors and in certain processes combinations of the above.

Typically the dilute phase is dewatered by applying pressure in belt presses, other type of presses, or decanter centrifuges. The dewatered cake typically has a concentration of 13% DS to 30% DS and is further treated by thermal drying, lime stabilisation, composting, solar drying or by use in land fill.

The cost of the final disposal depends on the DS content of the sludge. The higher the DS the lower the cost.

In 2006 Glendinning et al reported the application of electro-dewatering to dewater sewage sludges during pressing of the sludge in a commercially sized belt press. This yielded up to 30% DS at very economical power consumption rates.

The application of electric fields results in the processes of electrocoagulation, electrophoresis and electroosmosis which either individually or collectively increase the dewaterability of the sludge.

However significant electric power is required to drive such dewatering and the provision of highly specialised belts is also required. As such the proposal is disadvantageous.

### OBJECT OF THE INVENTION

It is therefore an object of the present invention to provide a method of treating sludges which will obviate or minimise the foregoing disadvantages in a simple yet effective manner or will at least provide the public with a useful choice.

### STATEMENT OF THE INVENTION

Accordingly in one aspect the invention consists in a method of treating sludges including steps of applying an electric field to the sludge to effect dewatering substantially prior to further dewatering of the sludge.

Preferably the sludge comprises dilute phase sludge.

Preferably the electric field is a DC electric field.

Preferably prior to applying electric field the pH of the sludge is adjusted to between substantially 5 and substantially 6.

Preferably the pH is adjusted by addition of an acid.

Preferably the acid is sulphuric acid or hydrochloric acid.

Preferably the electric field is applied through carbon, or graphite, or carbon fibre, or stainless steel electrodes.

Preferably the electrodes are carbon or graphite or carbon fibre.

Preferably the voltage of the DC field applied to the sludge is between substantially 2 volts and substantially 20 volts.

Preferably the voltage of the DC field applied to the sludge is between substantially 2 volts and substantially 14 volts.

Preferably the voltage applied to the sludge is between substantially 3 volts and substantially 5 volts.

Preferably the current density of the DC field applied to the sludge is between substantially 10 amps per square metre to substantially 80 amps per square metre.

Preferably the current density is from substantially 20 amps per square metre to substantially 40 amps per square metre.

Preferably the current density is substantially 22 amps per square metre.

Preferably the application time of the DC field to the sludge is from substantially 2 minutes to substantially 10 minutes.

Preferably the application time is substantially 5 minutes.

Preferably the temperature at which the treatment is effected is between substantially 15° C. and 37° C.

Preferably the temperature is between substantially 25° C. and 37° C.

Preferably the method further comprises adding polymer at a dose rate of substantially 4 kg per dry tonne to substantially 20 kg per dry tonne after the application of the electric field to the sludge.

Preferably the method further includes pressing or centrifuging the sludge after the polymer has been added.

In a further, aspect the invention consists in sludge when treated by a method according to any one of the preceding paragraphs.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawings in which:

FIG. 1 is a diagrammatic representation of equipment in which the method of the invention may be performed,

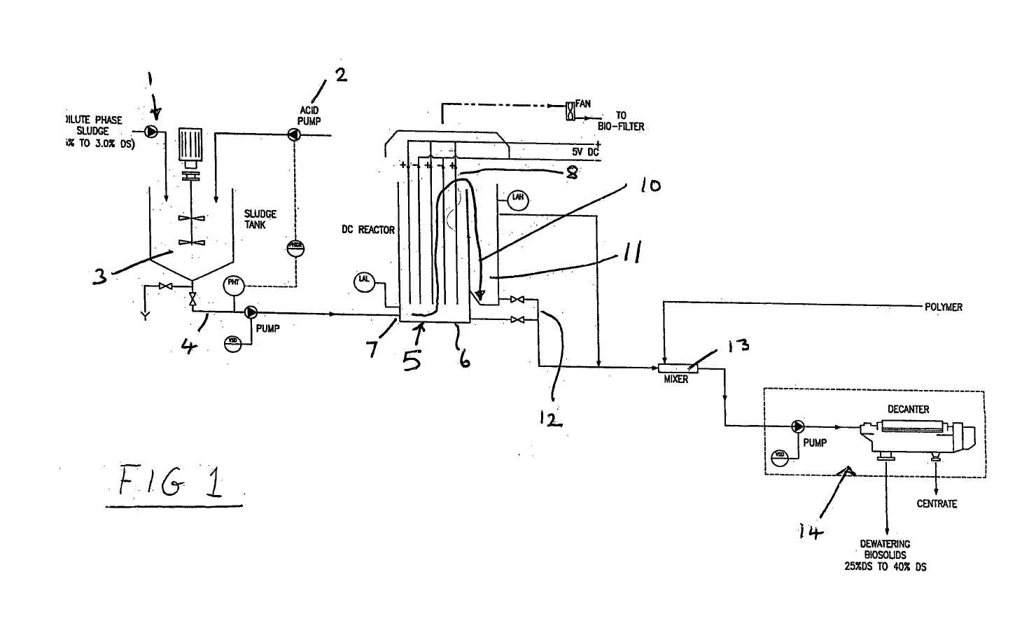

FIG. 2 is a perspective view and enlargement of an electric reaction tank for use in a preferred form of the invention, and

FIG. 3 shows how banks of electrodes can be built up for alternative reaction tanks usable in the invention.

### BEST MODE FOR CARRYING OUT THE INVENTION

Referring to drawings dilute phase sludge typically 0.5 to 4% more particularly 2 to 3% dry solids is provided at 1 and mixed with acid provided from an acid pump 2. Typically the acid is sulphuric acid or hydrochloric acid. The sludge and acid is mixed in a mixer 3 and when thoroughly mixed is taken through outlet pipe 4 to reactor 5. A typical flow rate of the dilute phase sludge is from about 10 to about 100 m³/h.

The reactor 5 applies a DC field across the sludge. The reactor 5 may comprise a holding vessel 6 with an inlet 7 towards to the bottom of the vessel 6. The vessel has therein a series of plates 8 across which the DC field is applied. In the example there are ten positive plates and ten negative plates. The gap between the plates is preferably from about 10 mm to about 30 mm. We have found about a gap of 15 mm gives good results.

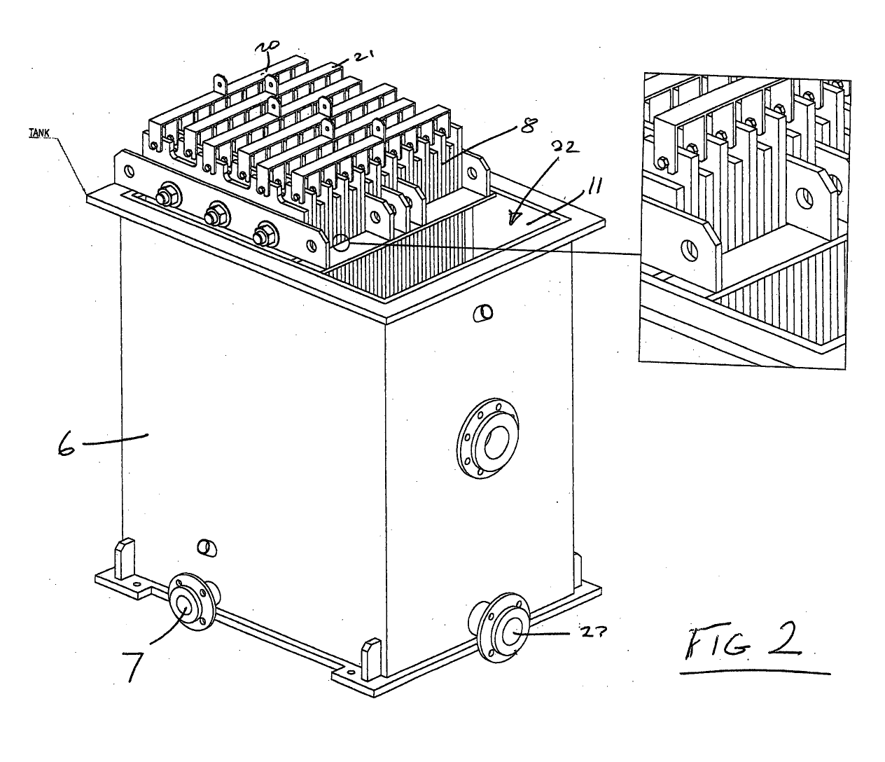

Referring now to FIG. 2 the inlet 7 feeds to the interior of holding vessel 6 in which plates 8 are positioned. Positive and negative plates are connected by electrically conducting bridges 20 and 21 connecting all positive or all negative plates 8. After passing upwardly past plates 8 the mixture passes downwardly at 22 to collection chamber 11 to outlet 23.

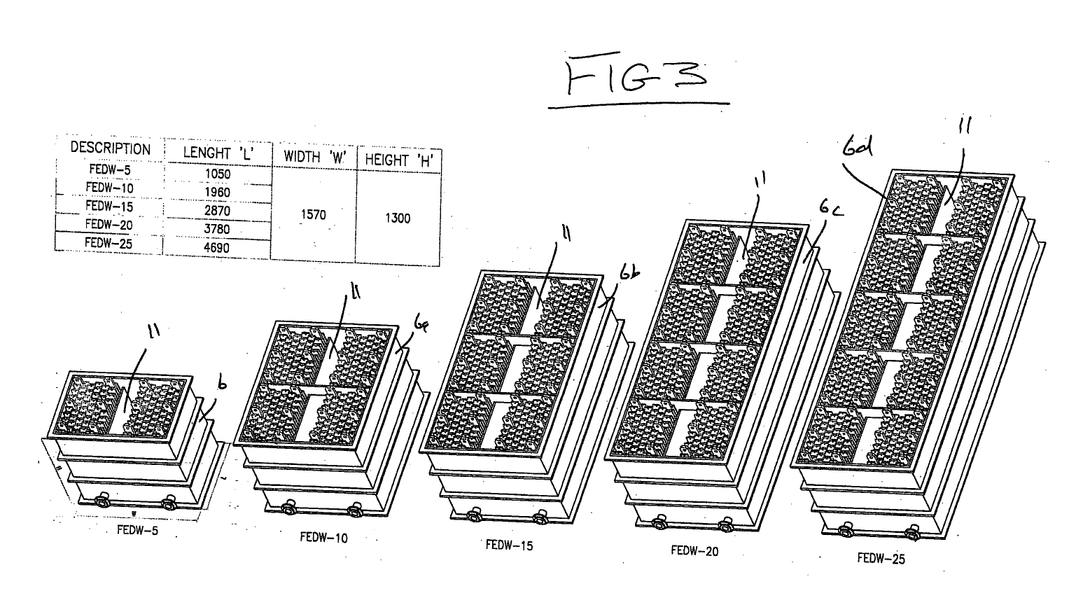

FIG. 3 shows how banks of plates 8 can be built up to provide a range of sizes of holding vessel 6, 6a, 6b, 6c, 6d. FIG. 3 shows the banks of plates in pairs, each pair having an inlet 7 and the chamber 11 being positional between each bank of plates 8 in the pair.

The DC field is desirably between 2 and 20 volts, preferably 2 and 14 volts, and most preferably between substantially 3 volts and substantially 5 volts. The current density is typically between 10 to 80 amps per square metre, preferably 20 to 40 amps per square metre. About 22 amps per square metre has been found to give good results. The current to achieve this current density will depend on the size of the plant being for example 60 to 400 amps preferably 100 to 200 amps.

The temperature in the reactor is adjusted to desirably be between substantially 15° C. and 37° C. and more particularly substantially 25° C. to substantially 37° C. Any desirable heating method can be used.

The sludge moves upwardly through the vessel 6 substantially in the direction of arrow 10 so as to collect in a collection chamber 11 after exiting the top of the reactor container 6. The sludge flows upwardly through a series of space provided between in the electrodes.

The speed of flow through the reactor 5 is adjusted so that the application time of the field to the sludge is between substantially 2 to substantially 10 minutes and most preferably substantially 5 minutes.

After exiting the chamber 11 to outlet 12 the sludge is mixed with a polymer typically a cationic coagulation agent in a mixer 13 from where the sludge travels to a further dewatering stage at 14 which may be of known form, for example, belt presses, centrifuges or the like. The final dry solids could be 25% DS to 40% DS.

In trials studies were collected before the application of polymer and subjected to a bench scale process using the parameters outlined above. This sludge was processed after a time passage of 0.5 hours to 30 hours from collection. After subjecting the sludge to the DC field the polymer was added at a rate of about 4 kg per dry tonne to 20 kg per dry tonne.

It was found that at least 20% less polymer is required after the treatment in reactor 5 compared to conventional present day treatments. After pressing or centrifuging the dry solids content is increased by anything from about 10% to 70% after the polymer and centrifuging. Thus, for example, from an initial dry solids of 23% a final dry solids between 26.45% and 34.5% can be expected. Consumption of electricity varied between 25 to 100 kilowatt hours per dry tonne of solids.

Thus it can be seen the invention provides a method of assisting the dewatering of sludges in which savings can be achieved. Savings can be achieved in the amount of polymer used and also in the reduction of electricity consumption. It is also believed that time in the dryer could be reduced by substantially 50% which again effects a reduction in electricity consumption. Advantages of the system are that the application of a DC electric field is carried out when the fluid has low dry solids. At these low dry solids the application of electricity is easily carried out in a safe manner. Also existing polymer dosing and dewatering equipment in the wastewater treatment plant can be used as the method of the present invention provides a stand alone separate element which can be incorporated into the existing wastewater treatment plant.

It is believed that the two step process is more effective than the previously proposed application of electric fields during the pressing process.

Polymer use could be reduced by up to 20% to 50%.

Throughout the description and claims of this specification the word “comprise” and variations of that word, such as “comprises” and “comprising”, are not intended to exclude other additives, components, integers or steps.

1. A method of treating sludge, the method comprising:
applying an electric field to the sludge to effect dewatering substantially prior to further dewatering of the sludge.

2. The method as claimed in claim 1 wherein the sludge comprises dilute phase sludge.

3. The method as claimed in claim 1 wherein the electric field is a DC electric field.

4. The method as claimed in claim 1 further
adjusting the pH of the sludge between 5 and 6 prior to applying electric field.

5. The method as claimed in claim 4 wherein adjusting comprises adjusting the pH by addition of an acid.

6. The method as claimed in claim 5 wherein the acid comprises sulphuric acid or hydrochloric acid.

7. The method as claim 1 wherein applying includes applying the electric field through carbon, or graphite, or carbon fibre, or stainless steel electrodes.

8. The method as claimed in claim 7 wherein the electrodes comprise carbon or graphite or carbon fibre.

9. The method as claimed in claim 3 wherein the voltage of the DC field applied to the sludge is between 2 volts and 20 volts.

10. The method as claimed in claim 9 wherein the voltage of the DC field applied to the sludge is between 2 volts and 14 volts.

11. The method as claimed in claim 10 wherein the voltage applied to the sludge is between 3 volts and 5 volts.

12. The method as claimed in claim 3 wherein the current density of the DC field applied to the sludge is between 10 amps per square metre to 80 amps per square metre.

13. The method as claimed in claim 12 wherein the current density is from 20 amps per square metre to 40 amps per square-metre.

14. The method as claimed in claim 13 wherein the current density is substantially 22 amps per square metre.

15. The method as claimed in claim 1 wherein the application time of the DC field to the sludge is from 2 minutes to 10 minutes.

16. The method as claimed in claim 15 wherein the application time is substantially 5 minutes.

17. The method as claimed in claim 1 wherein the temperature at which the treatment is effected is between 150° C. and 370° C.

18. The method as claimed in claim 17 wherein the temperature is between 25° C. and 370 C.

19. The method as claimed in claim 1 wherein the method further comprises:
adding polymer at a dose rate of 4 kg per dry ton to 20 kg per dry ton after the application of the electric field to the sludge.

20. The method as claimed in claim 1, further comprising:
pressing or centrifuging the sludge after the polymer has been added.

21. (canceled)
